(19) United States
(12) Patent Application Publication
(10) Pub. No.: US 2026/0084123 A1
(43) Pub. Date: Mar. 26, 2026

(54) Pet Food Mixing System

(71) Applicant: John Grant, Littleton, CO (US)

(72) Inventor: John Grant, Littleton, CO (US)

(21) Appl. No.: 19/340,527

(22) Filed: Sep. 25, 2025

Related U.S. Application Data
(60) Provisional application No. 63/698,672, filed on Sep. 25, 2024.

(51) Int. Cl. B01F 27/707; A01K 5/01; A47J 43/044; A47J 43/07; A47J 43/08; B01F 27/112; B01F 33/501; B01F 35/32; B01F 35/53; B01F 101/18; B65D 25/24; B65D 25/28

(52) U.S. Cl. CPC B01F 27/707; A01K 5/0114; A47J 43/044; A47J 43/0711; A47J 43/0727; A47J 43/082; B01F 27/112; B01F 33/5014; B01F 35/3202; B01F 35/5312; A47J 2043/0449; B01F 2101/18; B65D 25/24; B65D 25/2888; B65D 2217/00

(57) ABSTRACT

A pet food mixing system is described. Embodiments of the pet food mixing system include a container and a mixing cover. The mixing cover can be defined by a second container having a plurality of baffles and being configured to mate with a rotatable mixing member. The mixing member can include a plurality of blades for mixing food.

### CROSS-REFERENCE TO RELATED APPLICATION

This application claims the benefit of U.S. Provisional Application No. 63/698,672, filed Sep. 25, 2024.

### BACKGROUND

Generally, dogs and cats are fed dry food, wet food that is often canned, or a mixture thereof. Since dry food is substantially more economical compared to wet food and it creates less trash (no cans to throw out), dry food is often preferred from an owner's perspective. Many dogs and cats, however, strongly prefer wet food and will often resist eating dry food until an owner relents and gives the pet their desired food choice.

Some owners mix wet food into a dry food base to entice the pet to eat all their food. The mixing of dry and wet food can be messy and can require the use of a household spoon. If the mixing is not uniform enough, the pet may choose to eat the wet food and leave some or all of the dry food uneaten. When water is added to dry food to soften it and create a broth, the mixing can cause spillage and leave residue on the counter or other mixing surface.

As such, a means for evenly mixing dry pet food and wet pet food is needed.

### BRIEF DESCRIPTION OF THE DRAWINGS

FIG. 1A is a front view of a pet food mixing system in a first configuration according to one embodiment of the present invention.

FIG. 1B is a back view of a pet food mixing system in a second configuration according to one embodiment of the present invention.

FIG. 1C is a perspective view of a pet food mixing system according to one embodiment of the present invention.

FIG. 2A is a top perspective view of a mixing cover according to one embodiment of the present invention.

FIG. 2B is a top view of a mixing cover according to one embodiment of the present invention.

FIG. 3A is a top view of a mixing container according to one embodiment of the present invention.

FIG. 3B is bottom perspective view of a mixing container according to one embodiment of the present invention.

FIG. 3C is a front view of a mixing container according to one embodiment of the present invention.

FIG. 4A is a side view of a mixing member according to one embodiment of the present invention.

FIG. 4B is a side view of a mixing member without a handle in a first orientation according to one embodiment of the present invention.

FIG. 4C is a perspective view of a mixing member without a handle in a second orientation according to one embodiment of the present invention.

### DETAILED DESCRIPTION

Embodiments of the present invention can include a means for mixing pet food in a container. The means for mixing pet food can include a pet food mixing system. The pet food mixing system can include, but is not limited to, a container and a mixing cover. Typically, the mixing cover can be configured to mix pet food and can be configured to mate with the container. The mixing cover and the container can be constructed from food-safe materials (e.g., stainless steel, polypropylene, or BPA-free plastics). In a first configuration, the mixing cover can be mated to the container where blades of the mixing cover can mix food located in the container. In the first configuration, the mixing cover can be located on top of the container. In a second configuration, the container can be located on top of the mixing cover and food can be located in the mixing cover. It is to be appreciated that the container may be disengaged from the mixing cover in the second configuration. The mixing cover can include baffles for directing food back towards the blades to allow for efficient mixing of the food.

In one embodiment, the mixing cover can include, but is not limited to, a mixing container and a mixing member. The mixing container can be substantially bowl-shaped and can include a plurality of baffles integrated into and extending out from an interior surface of the mixing container. The mixing container can include a pair of handles and a pair of support members. The pair of handles can typically be located on a top of the container and the pair of support members can be located on a bottom of the container. In some instances, the mixing container can include a recessed channel along a perimeter rim of the top of the mixing container to receive a portion of another container therein. For instance, a rim of a bowl (e.g., the container) can be partially received in the channel to mate the bowl to the mixing container. The mixing member can typically include a central shaft with one or more blades affixed at predetermined angles. The blades may be flat, curved, or paddle-shaped, and can be positioned to interact with internal baffles of the mixing container to redirect food flow. The combination of blades and baffles can be configured to enhance mixing efficiency. In one example, the blades may be of a rectangular form with a shallow transverse concave depression across a top face, creating a gently scooped profile. As can be appreciated, this can help move food in the container instead of merely bisecting the food. A curved distal end of some of the blades can help move food and allow for the blades to be placed proximate interior sides of the mixing container.

The mixing member can have a horizontally oriented rotating shaft with one or more blades extending therefrom. In one instance, the shaft can be operatively coupled to a handle for manual rotation by a user. Accordingly, when the mixing cover is placed over the container, the blades of the mixing member can be received in the food, and when rotated, can cause the food to be mixed. In another embodiment, the shaft may be coupled to a motor for automated operation. The container and a mixing container can be of standard construction and can be made in a variety of sizes from a variety of suitable materials. The mixing member can be made of any suitable materials including, but not limited to, plastic and metal.

In one example embodiment, the mixing member can be coupled to an electric motor that can be operatively connected to a power source. In one instance, the electric motor can be powered by a battery. In another instance, the electric motor can be powered by an electrical plug electrically connected to an outlet. Of note, embodiments are contemplated where the mixing member can be either hand cranked or connected to an electric motor. For instance, a handle portion can be removed and the shaft can be connected to an electric motor for turning.

In a typical implementation, a user can first load dry and wet pet food ingredients into the mixing container. The user can then affix the mixing member to the mixing cover. Next, the user can begin to mix the food by turning the mixing member. The blades of the mixing member can interact with the wet and dry food to pass the mixture through the baffles to redistribute ingredients, ensuring uniform mixing. In some instances, the mixing member can be removed and the mixed food can be presented in the mixing container to a pet. In another instance, the mixed food can be deposited into the container for presentation to the pet. After use, the mixing member and mixing container may be disassembled for cleaning.

In a first embodiment, the pet food mixing system can include, but is not limited to, a first container and a mixing cover. The first container can be substantially bowl-shaped. The mixing cover can be defined by a second container, a plurality of baffles, and a mixing member. The second container can be substantially bowl-shaped. The plurality of baffles can be integrated into and extending out from an interior surface of the second container. The mixing member can be removably and rotatably coupled to the second container. The mixing member can have a plurality of blades, a shaft, and a handle. The plurality of blades can include a first blade and a second blade each having a substantially rectangular shape and extending radially in opposite directions from the shaft. The plurality of blades can further include a third blade and a fourth blade. The third blade and the fourth blade can each have a substantially rectangular shape and extend radially in opposite directions from the shaft. The third blade and the fourth blade can each have a distal end being curved. The third blade and the fourth blade can typically be located proximate opposite ends of the shaft and the first blade and the second blade can be located between the third blade and the fourth blade. In one instance, the blades can be equidistantly spaced from one another. In one example, the plurality of baffles can include at least six baffles where a first baffle mirrors a second baffle, a third baffle mirrors a fourth baffle, and a fifth baffle mirrors a sixth baffle. The plurality of baffles can form channels for the plurality of blades to pass through.

In a second embodiment, the pet food mixing system can include, but is not limited to, a first container and a mixing cover adapted to removably couple to the first container. The first container can be substantially bowl-shaped. The mixing cover can include a second container and a mixing member. The second container can be substantially bowl-shaped and include a plurality of baffles integrated into and extending out from an interior surface of the second container. The second container can include a pair of support members on a bottom outer surface of the second container. The second container can further include a pair of handles on an upper rim of the second container. The mixing member can be removably and rotatably coupled to the second container. The mixing member can have (i) a shaft, (ii) a handle, and (iii) a plurality of blades extending radially from the shaft. The plurality of blades can include a first blade and a second blade each having a substantially rectangular shape and a third blade and a fourth blade each having a substantially rectangular shape with a curved distal end. The curved distal ends of the third blade and the fourth blade can each be substantially curved similar to a curve of the interior surface of the second container. The plurality of baffles can include a first baffle that mirrors a second baffle, a third baffle that mirrors a fourth baffle, and a fifth baffle that mirrors a sixth baffle. The third blade can be adapted to pass on an outside of the first baffle and the second baffle. The first blade can be adapted to pass between the first baffle, the second baffle, the third baffle, and the fourth baffle. The second blade can be adapted to pass between the third baffle, the fourth baffle, the fifth baffle, and the sixth baffle. The fourth blade can be adapted to pass on an outside of the fifth baffle and the sixth baffle.

In a third embodiment, a pet food mixing system can include a first container and a mixing cover. The first container can be substantially bowl-shaped. The mixing cover can consist essentially of: a second container being substantially bowl-shaped and including a plurality of baffles (i) integrated into and extending out from an interior surface of the second container, and (ii) having a first baffle mirrors a second baffle, a third baffle mirrors a fourth baffle, and a fifth baffle mirrors a sixth baffle; and a mixing member removably and rotatably coupled to the second container, the mixing member having (i) a shaft, (ii) a handle, and (iii) a plurality of blades extending radially from the shaft and including (a) a first blade and a second blade each having a substantially rectangular shape, (b) a third blade and a fourth blade each having a substantially rectangular shape with a distal end being curved, (c) the first blade and the second blade being located between the third blade and the fourth blade, and (d) the first blade extending radially in a first direction, the second blade extending radially in a second direction, the third blade extending in a third direction, and the fourth blade extending in a fourth direction

### Terminology

The terms and phrases as indicated in quotation marks (“ ”) in this section are intended to have the meaning ascribed to them in this Terminology section applied to them throughout this document, including in the claims, unless clearly indicated otherwise in context. Further, as applicable, the stated definitions are to apply, regardless of the word or phrase's case, to the singular and plural variations of the defined word or phrase.

The term “or” as used in this specification and the appended claims is not meant to be exclusive; rather the term is inclusive, meaning either or both.

References in the specification to “one embodiment”, “an embodiment”, “another embodiment, “a preferred embodiment”, “an alternative embodiment”, “one variation”, “a variation” and similar phrases mean that a particular feature, structure, or characteristic described in connection with the embodiment or variation, is included in at least an embodiment or variation of the invention. The phrase “in one embodiment”, “in one variation” or similar phrases, as used in various places in the specification, are not necessarily meant to refer to the same embodiment or the same variation.

The term “couple” or “coupled” as used in this specification and appended claims refers to an indirect or direct physical connection between the identified elements, components, or objects. Often the manner of the coupling will be related specifically to the manner in which the two coupled elements interact.

The term “directly coupled” or “coupled directly,” as used in this specification and appended claims, refers to a physical connection between identified elements, components, or objects, in which no other element, component, or object resides between those identified as being directly coupled.

The term “approximately,” as used in this specification and appended claims, refers to plus or minus 10% of the value given.

The term “about,” as used in this specification and appended claims, refers to plus or minus 20% of the value given.

The terms “generally” and “substantially,” as used in this specification and appended claims, mean mostly, or for the most part.

Directional and/or relationary terms such as, but not limited to, left, right, nadir, apex, top, bottom, vertical, horizontal, back, front and lateral are relative to each other and are dependent on the specific orientation of a applicable element or article, and are used accordingly to aid in the description of the various embodiments and are not necessarily intended to be construed as limiting.

### An Embodiment of a Pet Food Mixing System

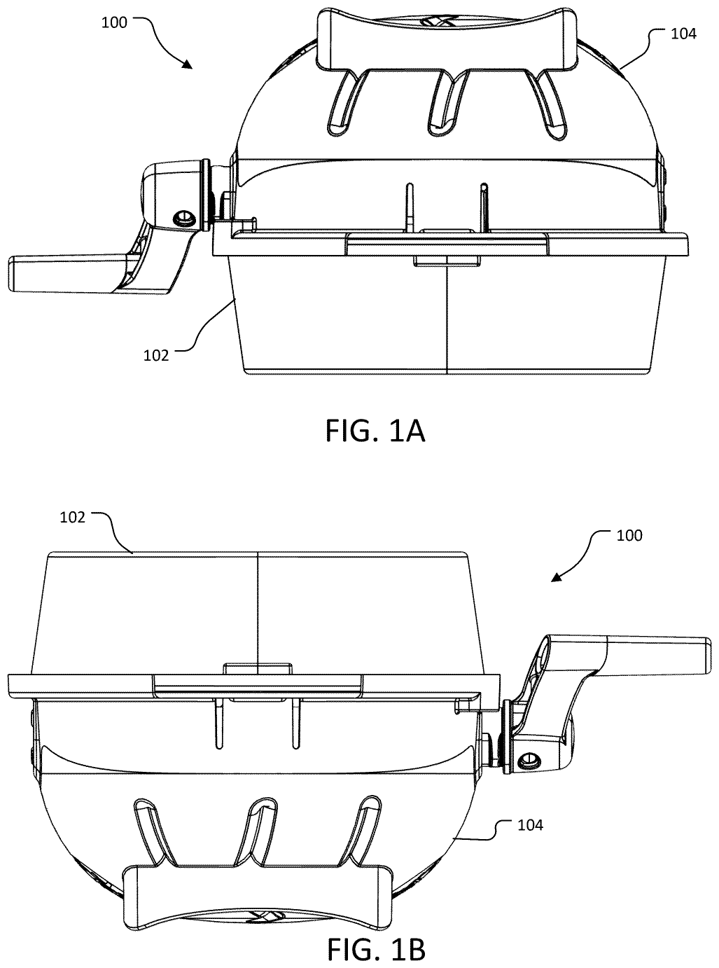

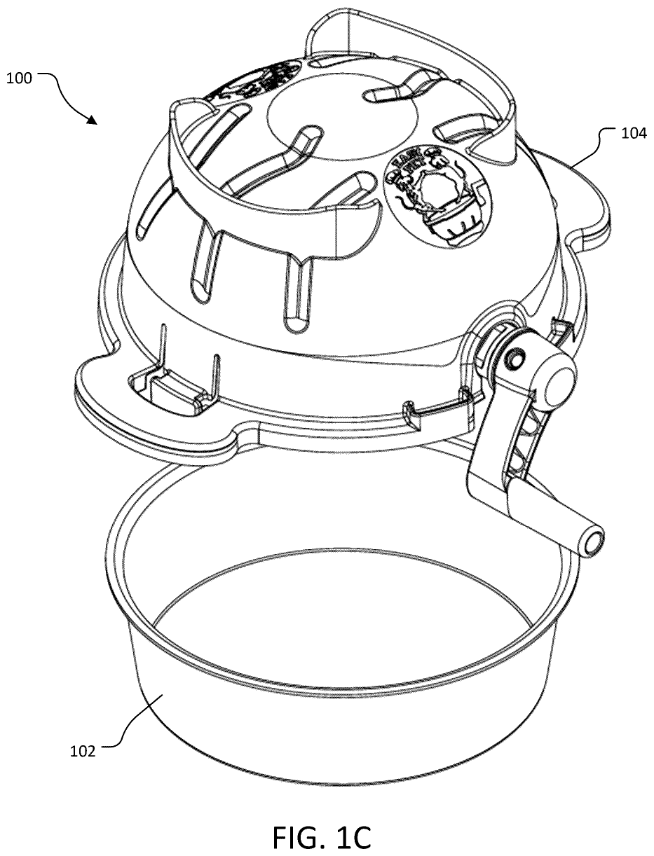

Referring generally to FIGS. 1A-4C, detailed diagrams of an embodiment 100 of a pet food mixing system and components thereof are illustrated. FIG. 1A includes a front view of the pet food mixing system 100 in a first configuration. FIG. 1B includes a front view of the pet food mixing system 100 in a second configuration. FIG. 1C includes a partially exploded view of the pet food mixing system 100. The pet food mixing system 100 can be implemented to mix pet foods having varying moisture content (e.g., dry dog food and wet dog food) together. One or more components of the pet food mixing system 100 can be used independently of other components of the system.

As shown, the pet food mixing system 100 can include, but is not limited to, a container 102 and a mixing cover 104. The mixing cover 104 can be configured to mate to the container 102. In some instances, the mixing cover 104 can be configured to mate with a pet food bowl in lieu of the container 102. It is to be appreciated that the mixing cover 104 may be implemented solely without the container 102 or another bowl. In FIG. 1A, the mixing cover 104 is shown on top of the container 102. Of note, when food may be mixed, the components are typically flipped with the container 102 on top of the mixing cover 104, as shown in FIG. 1B. Once the food has been thoroughly mixed, the components can be flipped back as shown to allow the food to collect in the container 102.

The container 102 can be sized to hold pet food. Of note, the container 102 and the mixing cover 104 can be scaled to mix and hold larger or smaller amounts of food. The mixing cover 104 can be removably coupled to the container 102. In one example, the mixing cover 104 can be friction fit to an upper perimeter of the container 102. For instance, the mixing cover 104 can include a recessed channel along a rim of the mixing cover for receiving a portion a rim of the container 102 therein. As shown, the container 102 can be substantially bowl-shaped and be sized to mate with the mixing cover 104.

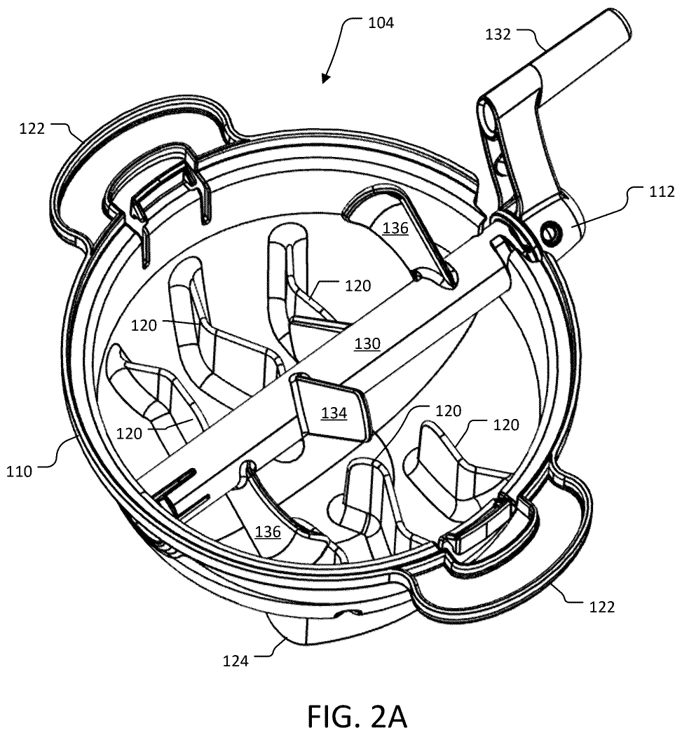

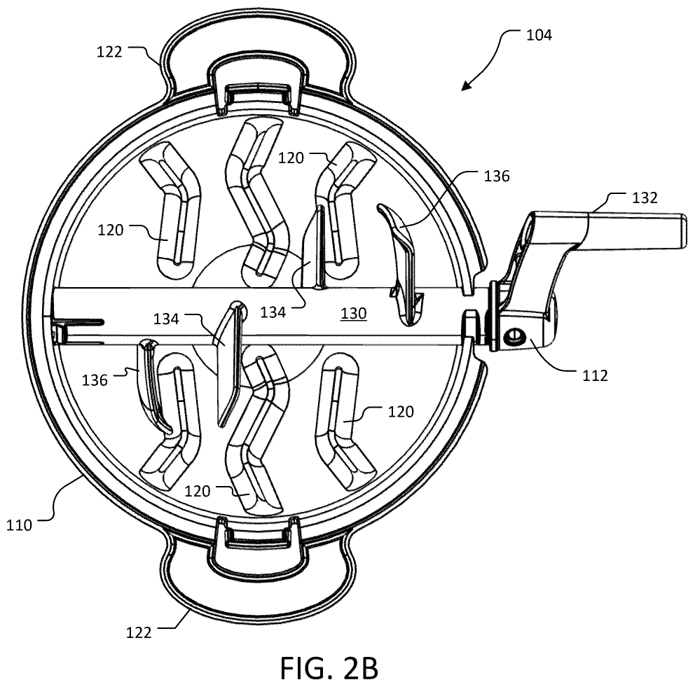

Referring to FIGS. 2A-2B, various views of the mixing cover 104 are illustrated. FIG. 2A includes a top perspective view of the mixing cover 104. FIG. 2B includes a top view of the mixing cover 104. As generally shown, the mixing cover 104 can include, but is not limited to, a substantially bowl-shaped container 110 (referred to hereinafter as the mixing container 110) and a mixing member 112. The mixing member 112 can be rotatably coupled to the mixing container 110. In one instance, the mixing member 112 can be removably coupled to the mixing container 110. As can be appreciated, this can allow for better cleaning of the components of the mixing cover 104. The mixing container 110 can include openings in sidewalls of the container for mating with the mixing member 112. As will be discussed hereinafter, components of the mixing member 112 can be rotatably coupled (or mated) to the mixing container 110.

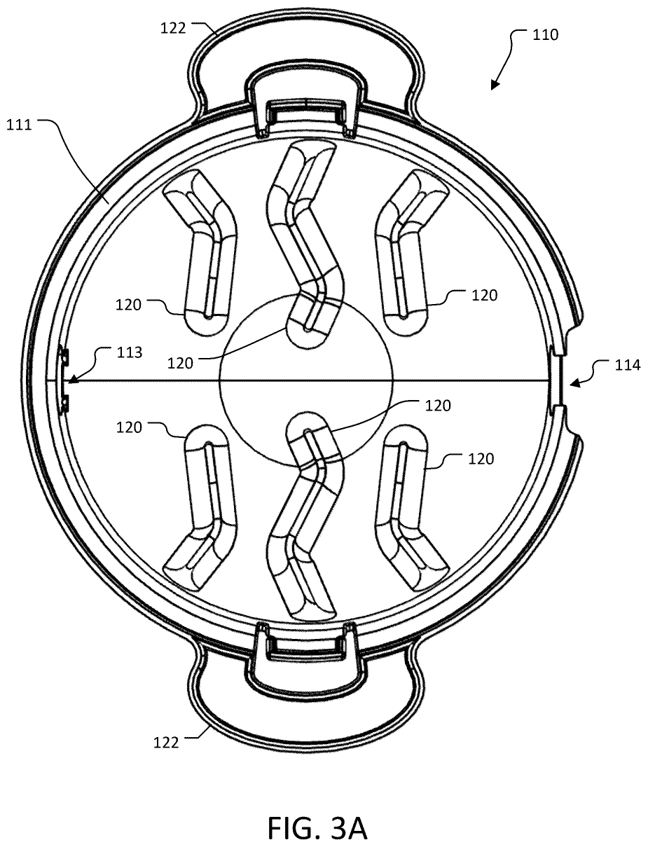

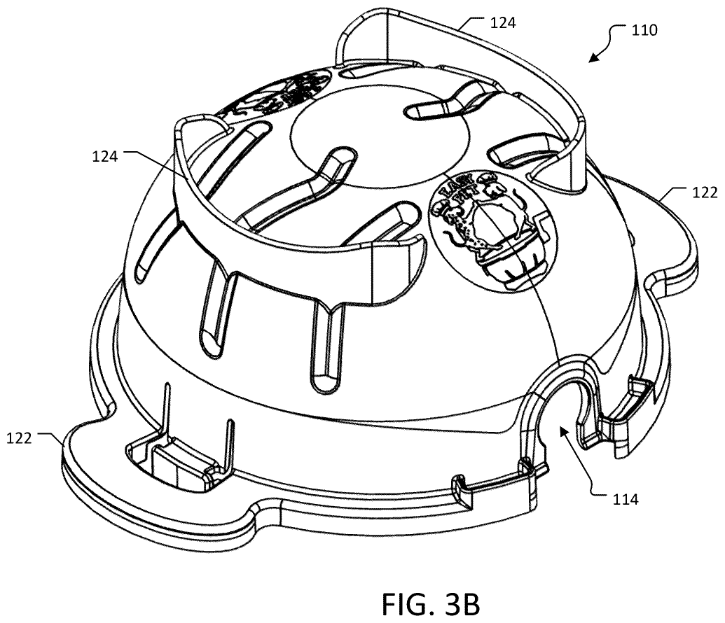

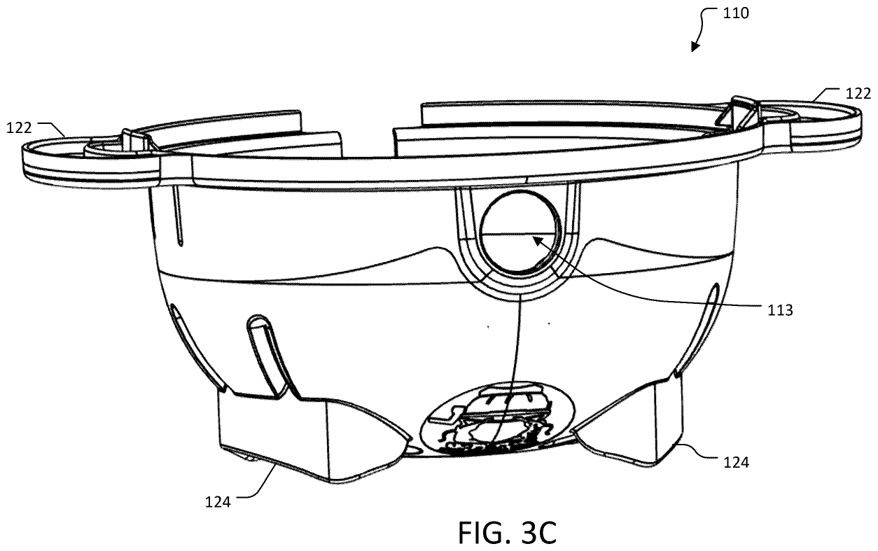

Referring to FIGS. 3A-3C, various views of the mixing container 110 are illustrated. FIG. 3A includes a top view of the mixing container 110. FIG. 3B includes a bottom perspective view of the mixing container 110. FIG. 3C includes a side view of the mixing container 110. As previously mentioned, the mixing cover 104 can include a means for mating to the container 102. As shown, the mixing container 110 can include a recessed channel 111. The recessed channel 111 can be configured to receive a portion of a rim of the container 102 therein. In general, the mixing container 110 can be configured to be removably coupled to the container 102. In some instances, a friction fit can be implemented between the containers. In other instances, a different type of coupling can be implemented to removably mate the mixing container 110 to the container 102. As shown, the mixing container 110 can include a plurality of baffles 120, a pair of handles 122, and a pair of support members 124. The mixing container 110 can typically be substantially bowl-shaped with the baffles 120 integrated into and extending out from an interior surface of the mixing container 110.

The mixing container 110 can include a first receptacle 113 and a second receptacle 114 for removably and rotatably coupling to the mixing member 112. The first receptacle 113 can be configured to receive a first end of a shaft of the mixing member 112 and the second receptacle 114 can be configured to receive a second end of the shaft of the mixing member 112. Of note, the shaft of the mixing member 112 can be adapted to rotate when mated with the first receptacle 113 and the second receptacle 114.

In a typical implementation, the plurality of baffles 120 can include at least six baffles. In one example, the baffles 120 can include a first baffle mirroring a second baffle, a third baffle mirroring a fourth baffle, and a fifth baffle mirroring a sixth baffle. The plurality of baffles 120 can form channels for the blades to pass through to mix food located in an interior of the mixing container 110. As generally shown, the plurality of baffles 120 can each have a wavy structure. For example, the each of the plurality of baffles 120 can have a sinusoidal or undulating shape when viewed from above. As shown, the middle baffles can extend further than baffles located proximate edges of the mixing container 110. Typically, the plurality of baffles 120 can be symmetrically distributed about a central axis of the mixing container 110. Of note, the plurality of baffles 120 can typically extend from proximate an interior curved and vertically extending wall to a middle of the mixing container 110. In some instances, a middle area of the mixing container 110 defined generally by a width of a shaft of the mixing member 112 can define an end of the plurality of baffles 120 proximate a middle of the mixing container 110. Of note, the shape of the plurality of baffles 120 can aid in mixing food in the mixing container 110. More specifically, food can be moved depending on which baffle the food is located next to. This can help ensure that food is constantly being mixed and not just moved in the same general motion.

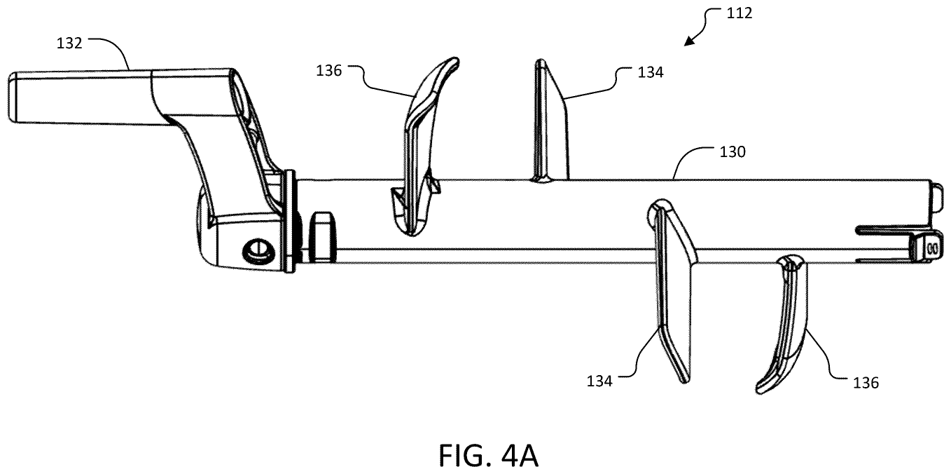

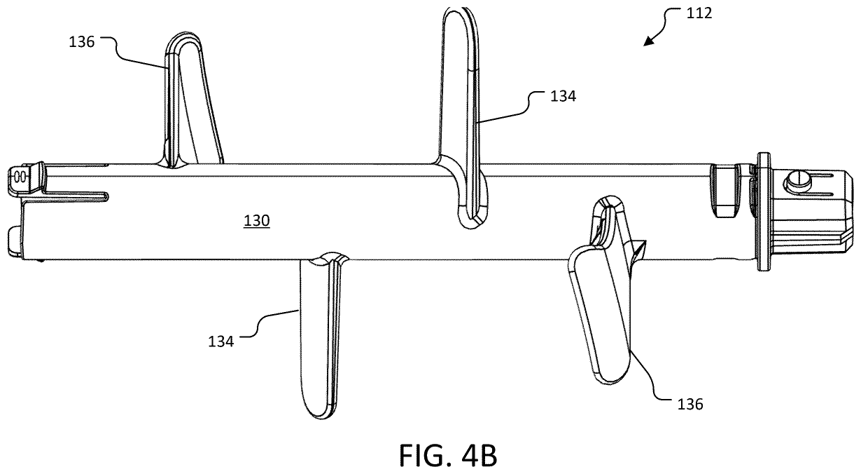

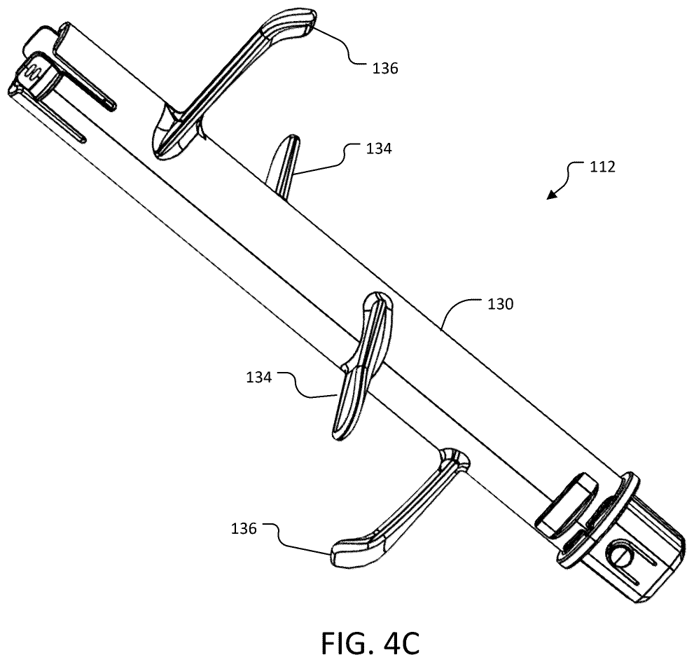

Referring to FIGS. 4A-4C, various views of the mixing member 112 are illustrated. FIG. 4A includes a side view of the mixing member 112. FIG. 4B includes another side view of the mixing member 112 in a different orientation. FIG. 4C includes a perspective view of the mixing member 112.

As generally shown, the mixing member 112 can include, but is not limited to, a shaft 130, a handle 132, and a plurality of blades 134, 136. The plurality of blades 134, 136 can typically include a first pair of blades 134, and a second pair of blades 136. The shaft 130 can be configured to removably and rotatably mate (or couple) to the mixing container 110. In some instances, the handle 132 can be integral with the shaft 130. In other instances, the handle 132 may be removably coupled to the shaft 130. The plurality of blades 134,136 can be sized to be close enough to the interior surface of the mixing container 110 without directly touching the interior surface. For instance, a distance of approximately 1 mm may be implemented between a distal end of a blade and the interior surface of the mixing container 110 when the mixing member 112 may be affixed to the mixing container 110.

The first pair of blades 134 and the second pair of blades 136 can each extend out radially from the shaft 130. Typically, the first pair of blades 134 can be located on either side of approximately a middle of the shaft 130. The second pair of blades 136 can be located outside of the first pair of blades 134 closer to ends of the shaft 130. In a typical implementation, the first pair of blades 134 can be located on opposite sides of the shaft 130 and be approximately oriented 180 degrees from one another. Similarly, the second pair of blades 136 can be located on opposite sides of the shaft 130 from one another and extend in opposite directions from the shaft 130. In one example, the first pair of blades 134 can be oriented approximately 45 degrees from parallel with the second pair of blades 136.

As generally shown, the first pair of blades 134 and the second pair of blades can each be defined by a generally rectangular cross-section. In one instance, the plurality of blades 134,136 can each have a substantially rectangular shape with a concave curvature across a short axis of the blades. Stated alternatively, the blades 134,136 can each have a concave curvature that is transverse. A distal end of the first pair of blades 134 can be curved to match a curvature of the mixing container 110. As shown, the distal end of blades 134 can be slightly flared and curve inwards towards a middle of the shaft 130. As can be appreciated, this can allow for the blades to pass closely by the interior surface without directly interfacing with the interior surface of the mixing container 110. Further, the curved distal end can be adapted to scoop food when rotating.

Referring back to FIG. 2B, the first pair of blades 134 and the second pair of blades 136 are shown and how they may interact with the plurality of baffles 120. As shown, the first pair of blades 134 can each be adapted to pass on an outside of the baffles. The second pair of blades 136 can each be adapted to pass through a channel created by the baffles. Of note, the curved end of each of the first pair of blades 134 can match an interior curvature of the mixing container 110. As previously mentioned, the plurality of blades 134,136 can be configured to move food along with mix the food such that the blades 134, 136 and the baffles 120 mix the food as the mixing member 112 may be rotated. For instance, food moved by the blades 134,136 can be pushed towards the baffles 120 where the contour of the baffles 120 can help direct the food to be moved back towards a path of one of the plurality of blades 134,136. Of significant note, this can help mix wet food and dry food such that they are efficiently and sufficiently mixed.

### Alternative Embodiments and Variations

The various embodiments and variations thereof, illustrated in the accompanying Figures and/or described above, are merely exemplary and are not meant to limit the scope of the invention. It is to be appreciated that numerous other variations of the invention have been contemplated, as would be obvious to one of ordinary skill in the art, given the benefit of this disclosure. All variations of the invention that read upon appended claims are intended and contemplated to be within the scope of the invention.

I claim:

1. A pet food mixing system comprising:
a first container being substantially bowl-shaped; and
a mixing cover, the mixing cover defined by:
a second container being substantially bowl-shaped;
a plurality of baffles integrated into and extending out from an interior surface of the second container; and
a mixing member removably and rotatably coupled to the second container, the mixing member having a plurality of blades, a shaft, and a handle.

2. The pet food mixing system of claim 1, wherein the plurality of blades includes a first blade and a second blade each having a substantially rectangular shape and extending radially from the shaft.

3. The pet food mixing system of claim 2, wherein the first blade extends radially in an opposite direction to the second blade.

4. The pet food mixing system of claim 2, wherein the plurality of blades further includes a third blade and a fourth blade each having a substantially rectangular shape and extending radially from the shaft, the third blade and the fourth blade each having a curved distal end.

5. The pet food mixing system of claim 4, wherein the third blade extends radially in an opposite direction to the fourth blade.

6. The pet food mixing system of claim 1, wherein the plurality of blades includes (i) a first blade and a second blade each having a substantially rectangular shape and extending radially from the shaft, (ii) a third blade and a fourth blade each having a substantially rectangular shape with a distal end being curved, and (iii) the third blade and the fourth blade each extending radially from the shaft.

7. The pet food mixing system of claim 6, wherein the third blade and the fourth blade are located proximate ends of the shaft and the first blade and the second blade are located between the third blade and the fourth blade.

8. The pet food mixing system of claim 1, wherein the plurality of baffles include at least six baffles.

9. The pet food mixing system of claim 8, wherein a first baffle mirrors a second baffle, a third baffle mirrors a fourth baffle, and a fifth baffle mirrors a sixth baffle.

10. A pet food mixing system comprising:
a first container being substantially bowl-shaped; and
a mixing cover, the mixing cover defined by:
a second container being substantially bowl-shaped and including a plurality of baffles integrated into and extending out from an interior surface of the second container; and
a mixing member removably and rotatably coupled to the second container, the mixing member having (i) a shaft, (ii) a handle, and (iii) a plurality of blades extending radially from the shaft and including (a) a first blade and a second blade each having a substantially rectangular shape, and (b) a third blade and a fourth blade each having a substantially rectangular shape with a curved distal end.

11. The pet food mixing system of claim 10, wherein the third blade and the fourth blade are located proximate opposite ends of the shaft and the first blade and the second blade are each located between the third blade and the fourth blade.

12. The pet food mixing system of claim 10, wherein the plurality of baffles include at least six baffles.

13. The pet food mixing system of claim 12, wherein a first baffle mirrors a second baffle, a third baffle mirrors a fourth baffle, and a fifth baffle mirrors a sixth baffle.

14. The pet food mixing system of claim 13, wherein (i) the third blade is adapted to pass on an outside of the first baffle and the second baffle, (ii) the first blade is adapted to pass between the first baffle, the second baffle, the third baffle, and the fourth baffle, (iii) the second blade is adapted to pass between the third baffle, the fourth baffle, the fifth baffle, and the sixth baffle, and (iv) the fourth blade is adapted to pass on an outside of the fifth baffle and the sixth baffle.

15. The pet food mixing system of claim 10, wherein the first blade extends radially in an opposite direction to the second blade.

16. The pet food mixing system of claim 15, wherein the third blade extends radially in an opposite direction to the fourth blade.

17. The pet food mixing system of claim 10, wherein the curved distal ends of the third blade and the fourth blade are each substantially curved similar to a curve of the interior surface of the second container.

18. The pet food mixing system of claim 10, wherein the second container includes a pair of support members on a bottom outer surface of the second container.

19. The pet food mixing system of claim 18, wherein the second container further includes a pair of handles on an upper rim of the second container.

20. A pet food mixing system comprising:
a first container being substantially bowl-shaped; and
a mixing cover, the mixing cover consisting essentially of:
a second container being substantially bowl-shaped and including a plurality of baffles (i) integrated into and extending out from an interior surface of the second container, and (ii) having a first baffle mirroring a second baffle, a third baffle mirroring a fourth baffle, and a fifth baffle mirroring a sixth baffle; and
a mixing member removably and rotatably coupled to the second container, the mixing member having (i) a shaft, (ii) a handle, and (iii) a plurality of blades extending radially from the shaft and including (a) a first blade and a second blade each having a substantially rectangular shape, (b) a third blade and a fourth blade each having a substantially rectangular shape with a distal end being curved, (c) the first blade and the second blade being located between the third blade and the fourth blade, and (d) the first blade extending radially in a first direction, the second blade extending radially in a second direction, the third blade extending in a third direction, and the fourth blade extending in a fourth direction.
